(19) United States
(12) Patent Application Publication
(10) Pub. No.: US 2008/0057781 A1
(43) Pub. Date: Mar. 6, 2008

(54) MOUNTING ASSEMBLY FOR CONNECTORS

(75) Inventors: Yun-Lung Chen, Tu-Cheng (TW); Ming-Xian Sun, Shenzhen (CN); Li Tong, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,642

(22) Filed: Sep. 1, 2006

(51) Int. Cl. H01R 33/945

(52) U.S. Cl. 439/577

(57) ABSTRACT

A mounting assembly includes a support bracket for supporting a data storage device with a fixed connector thereon, a cable connector electrically coupled to the fixed connector of the data storage device, and a pivoting member pivotably mounted to the support bracket. The support bracket has a latch portion thereon. The pivoting member has an engaging portion for engaging with the latch portion of the support bracket, and a securing portion for pressing against the cable connector, to thereby secure the cable connector to the fixed connector of the data storage device.

### FIELD OF THE INVENTION

The present invention relates to mounting assemblies for connectors, and more particularly to a mounting assembly for securing a cable connector to a fixed connector of a data storage device for ensuring safe transmission of data.

### DESCRIPTION OF RELATED ART

A data storage device, such as a hard disk drive or an optical disk drive, is a vital component in electronic equipment, such as personal computers or servers. Such disk drives are typically connected to a host computer through a host interface connector for transfer of commands, status and data. The host computer accesses the disk drive and reads data from the disk drive and/or saves data to the disk drive. The disk drive is typically connected to the host computer via a cable and a cable connector that connects to a fixed connector of the disk drive. For compatibility, the connectors and interface protocol are standardized. Accordingly, the cable, cable connector, and fixed connector of the disk drive must comply with the same interface standard. There are several disk drive interface standards, e.g., Advanced Technology Attachment (ATA) and Small Computer System Interface (SCSI) that have become common in the last decade. In order to connect the disk drive to a motherboard of the host computer, a ribbon cable with two connectors must be attached. One end of the ribbon cable attaches to the fixed ATA connector of the disk drive and the other end attaches to a connector fixed on the motherboard. However, the conventional ATA connector of the disk drive has a plurality of pins arranged thereon. It is not only cumbersome to install the ribbon cable but also a poor connection can lead to a number of problems such as data loss, errors, and damage. In addition, the wide ribbon cable may hinder dissipation of heat generated by electronic devices in the host computer.

With the development of technology, disk drives are now being designed to comply with a newer standard, generally referred to as the Serial Advanced Technology Attachment (SATA) standard, which is the standard presently favored for newer computers for higher transfer rate of data. In addition, the cable connected to the SATA disk drive is very thin and thus less of a hindrance to flow of air in the host computer, thereby improving heat dissipation. Furthermore, the SATA disk drives have an advantage since they are hot-pluggable. However, the cable connector easily loosens after the SATA disk drives are hot-plugged or suffer from impact or vibration. It is especially troublesome to users or test engineers if the cable connector comes loose during the course of operation or testing. Therefore, an improved mounting assembly for connectors is desired to thereby overcome the above-mentioned disadvantages.

What is needed, therefore, is to provide a mounting assembly for securing a cable connector to a fixed connector of a data storage device, that ensures safe transmission of data.

### SUMMARY OF THE INVENTION

A mounting assembly includes a support bracket for supporting a data storage device with a fixed connector thereon, a cable connector electrically coupled to the fixed connector of the data storage device, and a pivoting member pivotably mounted to the support bracket. The support bracket has a latch portion thereon. The pivoting member has an engaging portion for engaging with the latch portion of the support bracket, and a securing portion for pressing against the cable connector to thereby secure the cable connector to the fixed connector of the data storage device.

Other advantages and novel features will be drawn from the following detailed description of preferred embodiment with the attached drawings, in which:

### BRIEF DESCRIPTION OF THE DRAWINGS

FIG. 1 is an exploded, isometric view of a mounting assembly in accordance with a preferred embodiment of the present invention comprising a support bracket, a pivoting member, a data storage device with a fixed connector, and a cable connector;

FIG. 2 is an enlarged, isometric view of the support bracket of FIG. 1, but viewed from another aspect;

FIG. 3 is a pre-assembled view of part of FIG. 1 before the cable connector is mounted to the fixed connector of the data storage device, but viewed from another aspect; and

FIG. 4 is an assembled view of FIG. 1.

### DETAILED DESCRIPTION OF THE INVENTION

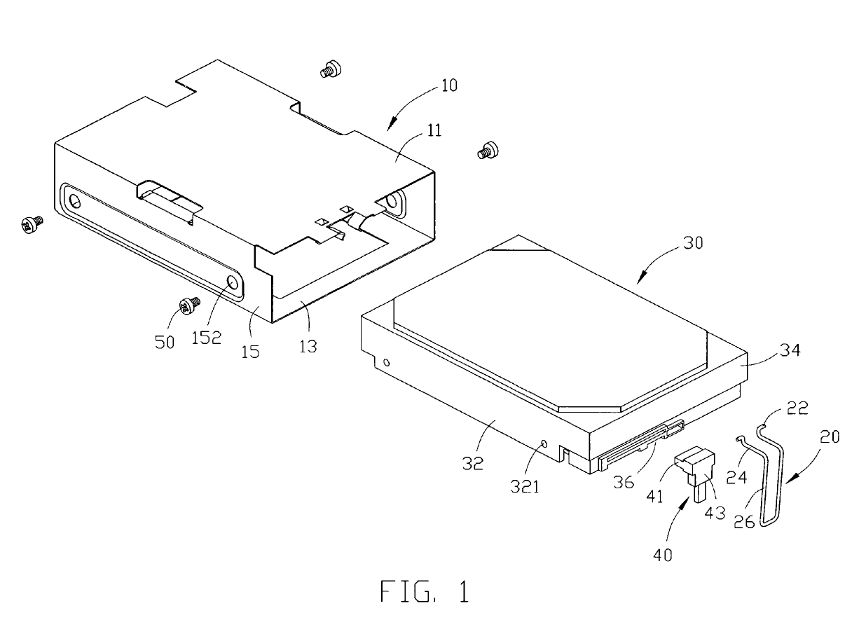

Referring to FIG. 1, a mounting assembly in accordance with a preferred embodiment of the present invention comprises a support bracket 10, a pivoting member 20, a data storage device 30 with a fixed connector 36, and a cable connector 40. The cable connector 40 is electrically coupled to the fixed connector 36 of the data storage device 30 to ensure normal transmission of data.

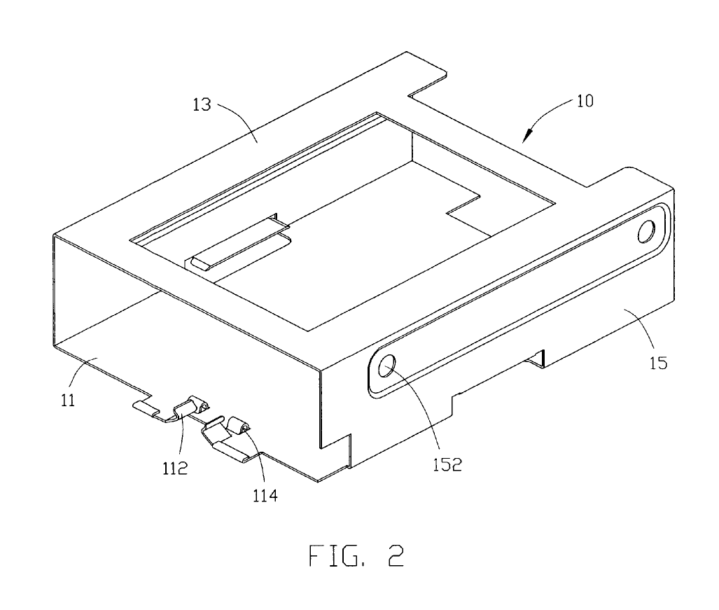

Referring to FIG. 2, the support bracket 10 is fixedly secured to a computer enclosure (not shown) by traditional means. The support bracket 10 comprises a top panel 11, a bottom panel 13, and two opposite side panels 15 connected with the top panel 11 and the bottom panel 13. A latch portion is formed on a rear end of the top panel 11. In the preferred embodiment, the latch portion is a pair of opposite S-shaped latching tabs 112 with two curves, formed on the top panel 11. A pair of pivot pins 114 is defined in the top panel 11, one of the pivot pins 114 adjacent to one of the latching tabs 112. A pair of through holes 152 is defined in each of the side panels 15 for extension of a pair of fasteners 50 therethrough, thereby securing the data storage device 30 in the support bracket 10.

The pivoting member 20 is made of a segment of folded metal wire. The pivoting member 20 is pivotably mounted on the top panel 11 of the support bracket 10. The pivoting member 20 forms a pair of pivot pins 22 at opposite ends thereof respectively, a pair of engaging portions 24 respectively connected with the corresponding pivot pins 22, and a U-shaped securing portion 26 connected with the pair of engaging portions 24. The securing portion 26 comprises a pair of branches each adjoining a corresponding engaging portion 24 to constitute a substantial L shape.

The data storage device 30 has two opposite side walls 32 and a rear wall 34 thereon. A pair of mounting holes 321 is defined in each of the side walls 32 of the data storage device 30. The fixed connector 36, located at the rear wall 34, is securely mounted on a printed circuit board (PCB) of the data storage device 30.

The cable connector 40 is electrically coupled to the fixed connector 36 of the data storage device 30. The cable connector 40 comprises an insert portion 41 for inserting in the fixed connector 36, and a compression portion 43 pressed by the securing portion 26 of the pivoting member 20.

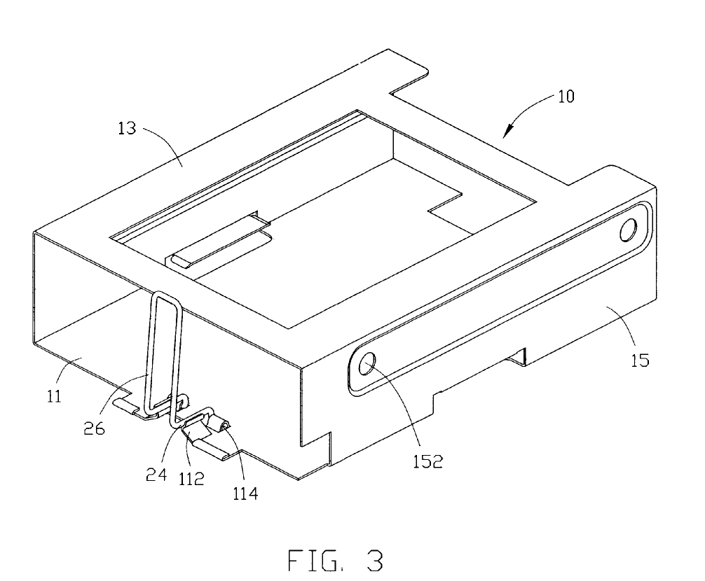

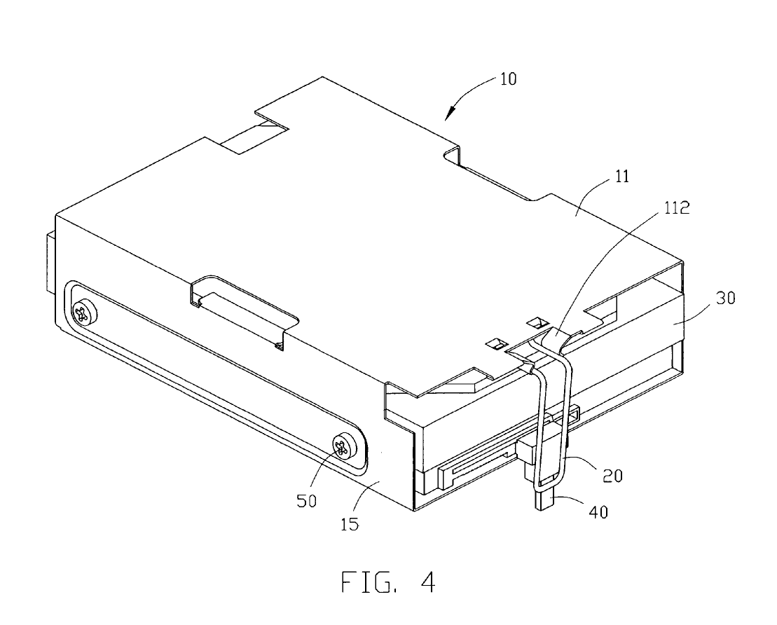

Referring also to FIGS. 3 and 4, in assembly of the pivoting member 20, the engaging portions 24 of the pivoting member 20 are pressed toward each other to urge the pivoting member 20 to deform. Then the pivot pins 22 of the pivoting member 20 align with the corresponding pivot holes 114 of the support bracket 10. When the engaging portions 24 of the pivoting member 20 are released, the pivot pins 22 extend through the corresponding pivot holes 114 of the support bracket 10, to thereby pivotably mount the pivoting member 20 on the support bracket 10.

Before the cable connector 40 is secured to the fixed connector 36 of the data storage device 30, the data storage device 30 is first inserted in the support bracket 10 to urge the mounting holes 321 of the data storage device 30 to align with the corresponding through holes 152 of the side panels 15 of the support bracket 10. The fasteners 50 are then extended through the corresponding through holes 152 of the support bracket 10 to engage in the corresponding mounting holes 321 of the data storage device 30, thereby securing the data storage device 30 to the support bracket 10. Alternatively, the data storage device 30 can be fixed on the support bracket 10 by other screwless means.

In assembly of the cable connector 40, the insert portion 41 of the cable connector 40 is first inserted into the fixed connector 36 of the data storage device 30. The pivoting member 20 is then rotated down from an unlocked position until the engaging portions 24 of the pivoting member 20 snappingly engage with curves of the corresponding latching tabs 112 of the support bracket 10 in a locked position. In this state, the securing portion 26 of the pivoting member 20 presses on the compression portion 43 of the cable connector 40 to further secure the cable connector 40 to the fixed connector 36 of the data storage device 30 in the locked position. Thus, even if the computer enclosure suffers from impact or vibration, the cable connector 40 remains electrically coupled to the fixed connector 36, thereby ensuring normal transmission of data.

In disassembly of the cable connector 40, the pivoting member 20 is rotated up from the locked position until the engaging portions 24 of the pivoting member 20 disengage from the curve of the corresponding latching tabs 112 of the support bracket 10. Simultaneously, the securing portion 26 of the pivoting member 20 disengages from the compression portion 43 of the cable connector 40. Thus, the pivoting member 20 is in the unlocked position and the cable connector 40 can be freely drawn out from the fixed connector 36 of the data storage device 30.

While the present invention has been illustrated by the description of preferred embodiments thereof, and while the preferred embodiments have been described in considerable details, it is not intended to restrict or in any way limit the scope of the appended claims to such detail. Additional advantages and modifications within the spirit and scope of the present invention will readily appear to those skilled in the art. Therefore, the present invention is not limited to the specific details and illustrative examples shown and described.

What is claimed is:

1. A mounting assembly comprising:
a support bracket for supporting a data storage device with a fixed connector thereon, the support bracket comprising a latch portion;
a cable connector electrically coupled to the fixed connector of the data storage device; and
a pivoting member pivotably mounted to the support bracket, the pivoting member having an engaging portion for engaging with the latch portion of the support bracket and a securing portion for pressing against the cable connector to thereby secure the cable connector to the fixed connector of the data storage device.

2. The mounting assembly as described in claim 1, wherein the support bracket comprises a top panel, and the latch portion is formed on the top panel.

3. The mounting assembly as described in claim 2, wherein the latch portion comprises a pair of opposite latching tabs formed on a rear end of the top panel of the support bracket.

4. The mounting assembly as described in claim 3, wherein each of the latching tabs is S-shaped.

5. The mounting assembly as described in claim 2, wherein a pair of pivot holes is defined in the top panel of the support bracket, and the pivoting member forms a pair of pivot pins extending into the corresponding pivot holes.

6. The mounting assembly as described in claim 1, wherein the pivoting member is made of a segment of folded metal wire.

7. The mounting assembly as described in claim 1, wherein the securing portion of the pivoting member is U-shaped.

8. A mounting apparatus for securing a first connector to a second connector, the mounting apparatus comprising:
a support bracket having a latch portion thereon; and
a pivoting member mounted to the support bracket and pivotable between a locked position and an unlocked position, the pivoting member having an engaging portion thereon for snappingly engaging with the latch portion of the support bracket in the locked position, and a securing portion connected with the engaging portion for pressing against the first connector to thereby prevent the first connector disengaging from the second connector in the locked position;
wherein the engaging portion of the pivoting member disengages from the latch portion of the support bracket when the securing portion is moved from the locked position to the unlocked position.

9. The mounting apparatus as described in claim 8, wherein the support bracket comprises a top panel, and the latch portion is formed on the top panel.

10. The mounting apparatus as described in claim 9, wherein the latch portion comprises a pair of opposite latching tabs formed on a rear end of the top panel of the support bracket.

11. The mounting apparatus as described in claim 10, wherein each of the latching tabs is S-shaped with two curves, and the engaging portion snappingly engages with the curves of the latching tabs in the locked position.

12. The mounting apparatus as described in claim 9, wherein a pair of pivot holes is defined in the top panel of the support bracket, and the pivoting member forms a pair of pivot pins extending through the corresponding pivot holes.

13. The mounting apparatus as described in claim 8, wherein the pivoting member is made of a segment of folded metal wire.

14. The mounting apparatus as described in claim 13, wherein the securing portion of the pivoting member is U-shaped, the pivot member further comprising another engaging portion, said an engaging portion and said another engaging portion respectively extending from opposite ends of the securing portion.

15. The mounting apparatus as described in claim 8, wherein the first connector is a cable connector, and the second connector is mounted on a data storage device which is fixedly received in the support bracket.

16. A mounting assembly comprising:
a support bracket comprising a latch portion;
a data storage device accommodated within the support bracket, a fixed connector securely mounted to the data storage device;
a pluggable connector electrically coupled to the fixed connector; and
a pivoting member pivotably mounted to the support bracket, the pivoting member having an engaging portion configured for snappingly engaging with the latch portion of the support bracket in a locked state, and a securing portion configured for pressing against the pluggable connector toward the fixed connector to thereby prevent the pluggable connector disengaging from the fixed connector in the locked state.

17. The mounting assembly as claimed in claim 16, wherein the latch portion comprises a pair of latching tabs, and the pivoting member comprises a pair of spaced engaging portions compressed between the latching tabs in the locked state.

18. The mounting assembly as claimed in claim 17, wherein the securing portion is U-shaped and connected between the pair of engaging portions.

19. The mounting assembly as claimed in claim 18, wherein the securing portion comprises a pair of branches each adjoining a corresponding engaging portion to constitute a substantial L shape.

20. The mounting assembly as claimed in claim 16, wherein the support bracket comprises a pair of side panels and a pair of connecting panels connecting upper and lower sides of the side panels respectively, the data storage device is received between the side panels and the connecting panels, the latch portion is formed at one of the connecting panels, and the fixed connector is located near the other one of the connecting panels.
